(19) United States
(12) Patent Application Publication
(10) Pub. No.: US 2008/0162239 A1
(43) Pub. Date: Jul. 3, 2008

(54) ASSEMBLY, AND ASSOCIATED METHOD, FOR PLANNING COMPUTER SYSTEM RESOURCE REQUIREMENTS

(75) Inventors: Guy Mitchell, Aurora, CO (US); Robert Wilcox, Dallas, TX (US); Reinier J. Aerdts, Plano, TX (US)

Correspondence Address: DOCKET CLERK, P.O. BOX 12608, DALLAS, TX, 75225, US

(73) Assignee: ELECTRONIC DATA SYSTEMS CORPORATION, Plano, TX (US)

(21) Appl. No.: 11/671,061

(22) Filed: Feb. 5, 2007

Related U.S. Application Data
(60) Provisional application No. 60/882,657, filed on Dec. 29, 2006.

(51) Int. Cl. G06Q 10/00

(52) U.S. Cl. 705/8; 705/7

(57) ABSTRACT

A capacity planning project planning tool, and an associated method, for a computer system. Planning is provided by which to determine computer system resource requirements needed pursuant to a project. A common data base is created and populated with planning data related to the system planning project. The data stored at the common data base is dynamically updatable. A capacity planner utilizes the planning data stored at the common data base. The capacity planner plans the computer system resource requirements and adjusts the plan responsive to dynamic updates to the planning data.

### CROSS REFERENCE TO RELATED APPLICATION

The present invention claims priority to provisional patent application Ser. No. 60/882,657, filed on 29 Dec. 2006, the contents of which are incorporated herein by reference.

The present invention relates generally to a manner by which to facilitate configuration and upgrading of a computer system, such as an integrated, multi-function, multi-site network arrangement of computer stations. More particularly, the present invention relates to apparatus, and an associated method, for creating a plan identifying computer system requirements of a computer system.

Data pertaining to systems needs are collected and maintained at a common database, and the collected data is used to determine computer system resource requirements. The data is dynamically updatable and the determination of the computer system resource requirements is correspondingly updatable.

### BACKGROUND OF THE INVENTION

The need to collect, store, and process data is a regular requirement of many facets of modern society. As a result of advancements in digital technologies and in mass storage technologies, sophisticated data storage and processing devices have been developed and deployed to facilitate the collection, storage and processing of the data. With continued advancements, further development and deployment of yet more sophisticated data storage and processing mechanisms is likely. Storage devices are constructed, for instance, to be of large storage capacities, sometimes on the order of terabytes of data, permitting redundant storage of data and ready retrieval thereof.

Data is stored for many purposes, subsequently retrieved and processed pursuant to many different applications and services. Disparately-positioned computers are sometimes interconnected, permitting data to be stored at one computer to be retrieved and processed, or otherwise utilized, at another of the computers. When such computers are interconnected by way of a high-speed connection, the retrieval rate is correspondingly rapid. Business, and other, enterprises, having enterprise operations positioned at disparate locations having computer stations maintained at different ones of the enterprise locations sometimes, provide for interconnection of the computers maintained at the disparate locations, to permit personnel positioned at one location to access data stored at the computers of other locations. When the enterprise is large, maintenance of the overall computer system sometimes becomes quite challenging. And, even in enterprise organizations of small size, computer system maintenance is also sometimes quite challenging to the enterprise personnel.

Amongst the computer system maintenance requirements is the need to maintain the computer system capacity so that the computers of the computer system are of storage and processing capacities capable to meet the storage and computing requirements of the enterprise. As data storage and processing becomes more pervasive throughout greater aspects and operations of a business enterprise, the storage and processing requirements of computer system generally increases over time. And as an enterprise expands its operations, the computer-system capabilities must correspondingly keep pace.

Computer system upgrades and reconfigurations are, accordingly, regularly required. Such planning is usually a difficult endeavor, particularly when an enterprise is formed of multiple operating units, each with separate computer support personnel, and reporting structures. Collection of information related to an existing computer system and other information related to the computer system regularly becomes a burdensome task. An analyst, or other person or group, charged with collecting information related to the computer system needed to carry out a planning project might well encounter many obstacles. In a typical scenario, the analyst requests the appropriate, enterprise personnel to provide a completed, capacity planning resource impact form that identifies details related to a computer system configuration and other system requirements. System requirements include, e.g., business requirements that can be translated into technology requirements and capacity demand signals. The form must be correctly completed, and reprovided to the appropriate parties for processing. In an end-to-end environment, that is to say an IT (information technology) environment having a system configuration that spans multiple, traditional towers, a network, a mainframe computer, mid-range computers, storage devices, network components, and applications, multiple personnel, sometimes, located in different locations and operating groups, must all provide input in order properly to complete the form. With each additional person required to provide information for its completion, the likelihood that a problem in its completion increases.

Once the form is completed and provided to the analyst, the analyst reviews the completed form. Sometimes additional information is required, necessitating the analyst to search for the proper parties to provide the additional information. In short, conventional manners by which to gather information and subsequently plan for a computer system reconfiguration or upgrade is replete with difficulties.

If an improved manner could be provided by which to create a computer system capacity plan, planning would be much more easily carried out.

It is in light of this background information related to computer systems and planning for their configuration and upgrade that the significant improvements of the present invention have evolved.

### SUMMARY OF THE INVENTION

The present invention, accordingly, advantageously provides apparatus, and an associated method, by which to facilitate configuration and upgrading of a computer system, such as an integrated, multi-function, multi-site network arrangement of computer stations.

Through operation of embodiment of the present invention, a manner is provided for creating a plan that identifies computer system requirements of a computer system.

In one aspect of the present invention, data pertaining to system needs is collected and maintained at a common database, and the collected data is used to determine computer system resource requirements. The data is dynamically updatable and the determination of the computer system resource requirements is correspondingly updatable.

In another aspect of the present invention, a common database, a logically or physically centralized data depository, is provided at which to store data related to a computer system configuration and statistics associated with the system. Once stored at the common database, the data is subsequently, readily accessible due to its storage in electronic form at the database. When the information is collected from multiple parties located, e.g., at multiple locations, the information is permitted to be entered locally, that is to say, at a computer station of the computer system in proximity to the person that is cognizant of the respective information. Misplacing of information is less likely to occur as the information is maintained at the database, in electronic form.

In another aspect of the present invention, the information, once collected and stored at the common database, is used to create operations and schedules, details of which are at least selectably accessible.

In another aspect of the present invention, hardware planning information is further maintained. The hardware planning information includes, for instance, existing hardware of the computer system as well as identified hardware needs. The existing hardware and the identified hardware needs are entered, e.g., as part of the data and statistics that are stored at the common database.

In another aspect of the present invention, coverage is further provided, on a real-time basis, the resulting impact of implementations made to the computing environment. Oversight of the processes thereby is able to be monitored in real-time. And, data stored at the common database, has been updated, and is accessible in real-time.

In another aspect of the present invention, parsing of the data stored at the common database is provided. Technical planning and performance is provided.

In another aspect of the present invention, reports are generated responsive to the data and statistics stored at the common database. The reports selectably include operations and schedules, hardware planning information, and the results of the coverage on the real-time basis.

In another aspect of the present invention, capacity planning is provided. A capacity planner creates a plan that identifies computer resource requirements pursuant to reconfiguration or update of a computer system. As part of the planning process, enterprise-growth requirements are gathered from the data and statistics stored at the common database. Additional information, such as business requirements, is also collected. Capacity data is further collected, and current usage and service is evaluated. A determination is made pursuant to the planning process as to whether resources of the computer system should be redistributed. And, expected resource requirements are also evaluated. Responsive to such additional evaluation, determinations are made as to whether configuration changes of the computer system are needed and also as to whether additional resources are required. Any, or all, of the collected information, evaluations, and determinations are translatable into capacity signals.

The planning process is iterative to permit the planning process to be iteratively repeated, such as, at first, in a test environment, and thereafter in a production environment.

The collection of data at the common data base and subsequent planning to determine computer resource requirements is more efficiently carried out. Haphazard planning on an ad hoc basis is substituted with a planning tool that provides a sequential and ordered process by which to plan for the computer resource requirements of the reconfigured or updated computer system. Because the tool is constantly monitoring the database, which is being updated on a realtime basis, dynamic changes in conditions and capacity needs are able to be taken into account.

In these and other aspects, therefore, apparatus and an associated method, is provided for planning computer system resource requirements pursuant to a system planning project. A centralized data depository is configured to restore planning data related to the system planning project. The planning data is dynamically updatable. A capacity planner is adapted to utilize the planning data stored at the centralized data depository. The capacity planner is configured to plan the computer resource requirements for the system planning project. And, the capacity planner is further configured to adjust the plan in response to dynamic updates to the planning data.

A more complete appreciation of the present invention and the scope thereof can be obtained from the accompany drawings that are briefly summarized below, the following detailed description of the presently-preferred embodiments of the present invention, and the appended claims.

### BRIEF DESCRIPTION OF THE DRAWINGS

FIG. 1 illustrates an arrangement of computer stations forming a computer system pertaining to which the computer resource requirements are planned pursuant to operation of an embodiment of the present invention.

FIG. 2 illustrates a process diagram representative of the process of operation of an embodiment of the present invention.

FIG. 3 illustrates a process diagram representative of the process of operation, in greater detail, of a portion of the process of the process diagram shown in FIG. 2.

FIG. 4 illustrates a method flow diagram listing the operations of the method of an embodiment of the present invention.

### DETAILED DESCRIPTION

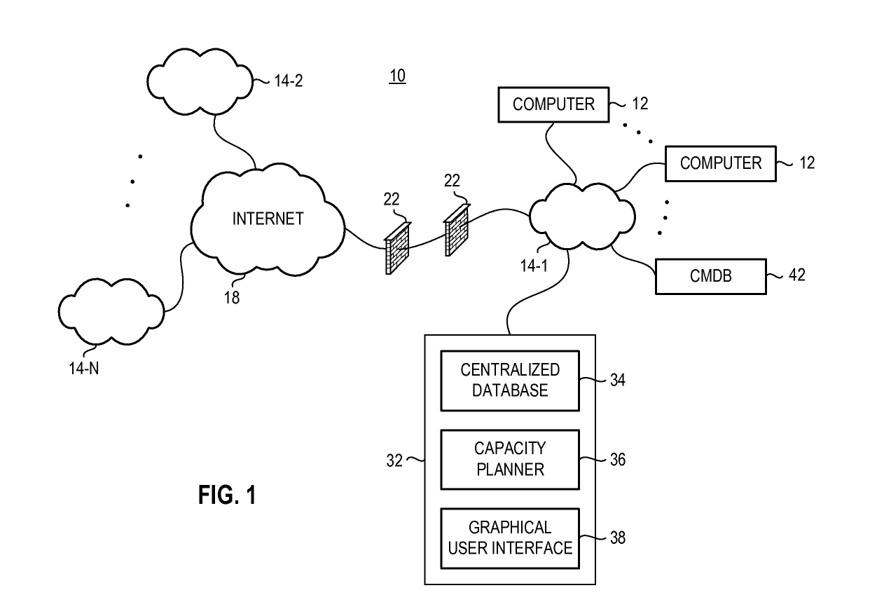

Turning first to FIG. 1, an arrangement, shown generally at 10, of computers, and other processing devices, together forms a computer system. The arrangement shown in FIG. 1 is exemplary, here representative of a business, or other enterprise, that has groups of logically, or physically connected computers or other processing devices. The arrangement shown in FIG. 1 shows a multi-location configuration in which the enterprise has computers positioned at disparate sites, e.g., sites at widely separated locations. Here, N groups 14 of computers 12 connected together to form local area networks. The local area networks are, in turn, connected, here by way of a public network, 18, such as the internet, thereby to provide communication connectivity between the computers of the different groups. The groups of computers forming the respective local area networks (LANs) are positioned, e.g., behind firewalls, such as the firewalls 22. Controlled access to data stored at individual ones of the computers 12 or to cause processing of data at respective ones of the computers is provided in conventional manner of computer systems.

As mentioned previously, computer systems oftentimes are not of static configurations; rather, the computer needs of the enterprise change, and the configuration and capabilities of the computer system must correspondingly change. Existing procedures are generally relatively inefficient, typically relying upon an analyst to enlist enterprise personnel to complete a capacity planning resource impact form, or the like, to identify various information associated with the computer system and projected resources associated with its alteration. Particularly when the enterprise is large, with disparate operations and computer personnel located at the disparate locations and reporting through separate reporting structures, creation of the list is sometimes problematical.

Pursuant to an embodiment of the present invention, apparatus 32 provides a planning tool for planning computer resource requirements of a computer system, such as the computer system illustrated in the arrangement 10 of FIG. 1. The apparatus 32 is here formed of functional elements, implementable in any desired manner, including, in part, algorithms executable by processing circuitry. The apparatus 32 is, merely for purposes of illustration, shown to be connected to the network 14-1. The apparatus 32 forming the capacity planning tool is connectable elsewhere, such as at other networks 14, the network 28, or elsewhere. The capacity planning tool forming the apparatus 32 is here shown to include a centralized data base 34, a capacity planner 36, and a graphical user interface 38.

The centralized database 34 provides a data depository at which data relating to various aspects of the computer system is stored and maintained. The data, information and statistics, stored at the database is collected pursuant to a capacity planning project to plan for the computer resource requirements of the computer system provided, e.g., by personnel of the enterprise that maintain the existing computer system or are otherwise involved with a capacity planning project. Once collected and stored, the data stored at the database is accessible and updatable as needed if data parameters or conditions require updating. Real time data, that is, data that is stored in a manner that is retrievable and reportable in a manner permitting business actions to be taken on the data is further provided by storing the data at the centralized, or common, database. Centralization of the data includes logical centralization in which the data is not stored at a single physical database, but rather is stored at a distributed database, with the contents of the data stored at the distributed data base commonly accessible as a common database. The use of real time data, howsoever defined, is usable to provide results that do not rely upon an ad hoc haphazard analysis.

Additionally, due to the capability to update the data stored at the central database, changing needs are better able to be taken into account. Capacity needs can be added on demand, and the capacity planning is able to be correspondingly added, on-demand. When a determination is made that a system requires capacity, planning provided by the capacity planning tool takes into account real-time data and adds capacity when the need arises, e.g., by way of MQ links, etc.

The capacity planner provides the plan of the computer resource requirements that shall be needed of the computer system, such as pursuant to the reconfiguration or updating of the computer system. Both software and hardware requirements are planned by the planner in the exemplary implementation. Additionally, planning is further provided, in the exemplary implementation, to identify how to distribute traffic across, e.g., an entire platform, or within a partition. Hardware planning includes, for instance, making decisions of the type of hardware that best matches the needs of the computer system. Recommendations are made, for instance, on the basis of “best value” according to a best-value definition.

And, the graphical user interface (GUI) 38 is used, not only to input data to the database 34, and to provide capacity planning algorithms for the planner 36, but also to provide for a real-time, graphical representation of data and information, such as through use of a front plane (tm) capability.

Additionally, connection and interaction with service levels, contained in a configuration management database (CMDB), located in a Cross Plane (tm), is further provided. The configuration management database comprises a centralized repository here represented at 42, containing IT, asset-related information, including service levels. The Cross Plane (tm), provides mechanisms to modify business processes, e.g., for provisioning. This layer provides real-time access to data of an operational data store and data warehouse.

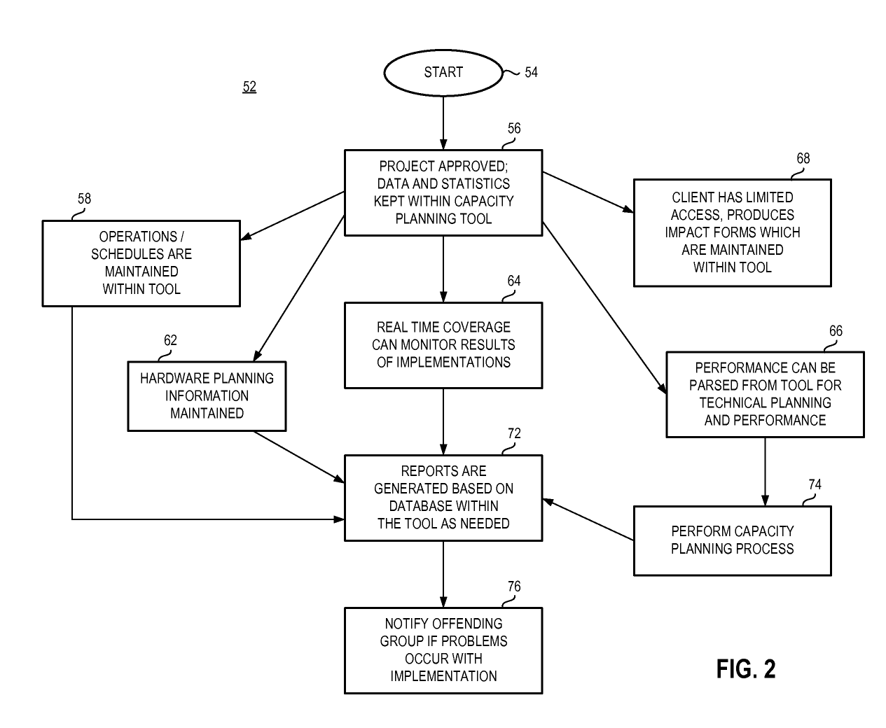

Turning next to FIG. 2, a process, shown generally at 52, is representative of exemplary operation of the apparatus 32 (shown in FIG. 1) by which to perform capacity planning of a computer system. Subsequent to entry indicated by the start block 54, project approval is obtained. And, as indicated by the block 56, data and statistics associated with the computer system are obtained and stored at the database of the capacity planning tool.

Once stored at the common database of the planning tool, various activities are performable by the planning tool. Operations and schedules are created and maintained, indicated by the block 58. And, hardware planning information is created and maintained, indicated by the block 62. Real time coverage is provided permitting monitoring of the results of implementations, indicated by the block 64. Performance is also parsed for technical planning and performance purposes, indicated by the block 66. And, access to the data maintained at the database is selectably accessible, e.g., by personnel of the enterprise at which the computer system is positioned or planned. As indicated by the block 68, impact forms are produceable, available for selectable access by the personnel of the enterprise. The selectable nature of the access permits managing entities of the enterprise to control which personnel are able to access the impact forms, and other data stored at the data base.

Reports are generated, indicated by the block 72. The reports are based upon the data stored at the data base. The reports include, for instance, reports based upon operations and schedules maintained at the tool, hardware planning information, and real-time coverage of implementation results.

And, as indicated by the block 74, capacity planning is further performed. The performance of the capacity planning corresponds to the functions provided by the capacity planner 36, shown in FIG. 1. Responsive to capacity plans related to computer resource requirements resulting from the capacity planning, making use of data stored at the data base.

The computer resource requirements identified in the capacity plan performed pursuant to the capacity planning process are further utilizable at the block 72 at which reports are generated. Additionally, and as indicated by the block 76, based upon generated reports, appropriate parties are notified of problems that occur with the computer planning implementation.

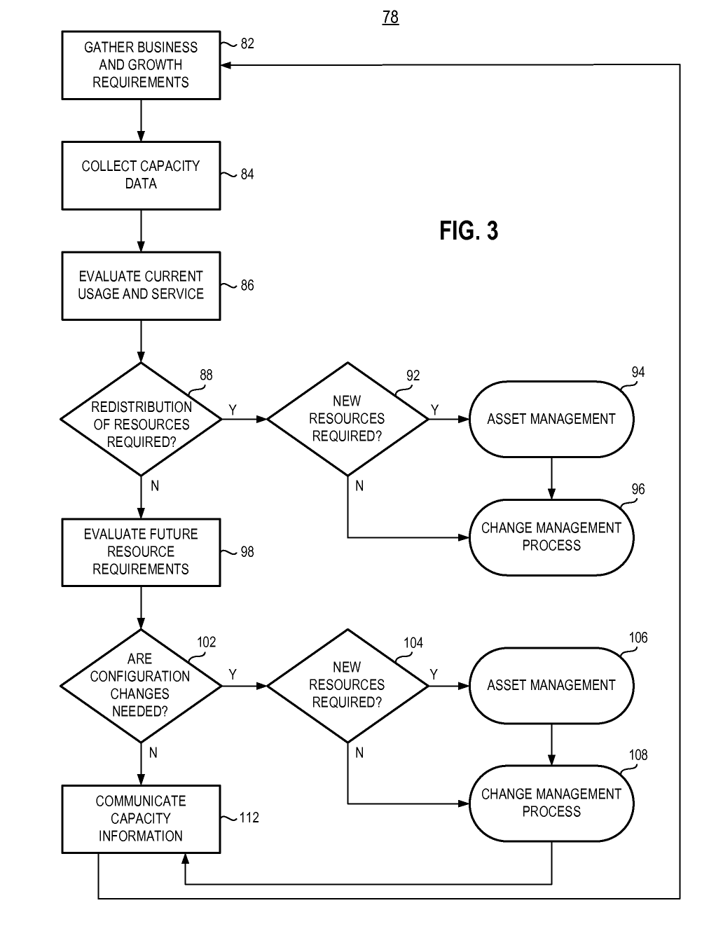

FIG. 3 illustrates a process, shown generally at 74, of exemplary planning performed pursuant to operation of an embodiment of the present invention. In its exemplary implementation, the planning process is iterative, and complies with QMS standards. Planning provides for the determination of computer resources that are required pursuant to a computer system need or enterprise objective. In one implementation, the process is first performed in a test environment and measured. And, once the capacity plan is updated with learned information, the capacity plan is measured again in production operations, and the capacity plan is updated.

First, and as indicated by the block 82, information related to business and growth requirements is gathered. Then, and as indicated by the block 84, capacity data is collected. Then, and as indicated by the block 86, current usage and service in an existing computer-system implementation is evaluated.

A determination is made, indicated by the decision block 88, as to whether a redistribution of existing resources is required. If so, the yes branch is taken to the decision block 92. At the decision block 92, a further determination is made, as to whether additional resources are required. If so the yes branch is taken to the block 94, and asset management is performed. If new resources are not required, the no branch is taken to the block 96, and the management process is changed. The path is further taken from the asset management block 94 to the change management process 96. And, subsequently, a path is taken back to the block 84.

If, at the decision block 88, a determination is made that a redistribution of resources is not required, a no branch is taken to the block 98. At the block 98, future resource requirements are evaluated. Then, a path is taken to the decision block 102. At the decision block 102, a determination is made as to whether configuration changes are required. If so, the yes branch is taken to the decision block 104. At the decision block 104, a further determination is made as to whether new resources are required. If so, the yes branch is taken to the block 106, and asset management is performed. Otherwise, the no branch is taken to the block 108, and the management process is changed. A path is also taken from the asset management block 106 to the block 108. Thereafter, a path is taken to the block 112, whereat capacity information is communicated to appropriate personnel, such as by way of a graphical user interface. A path is taken from the block 112 back to the block 82, thereby forming an iterative process.

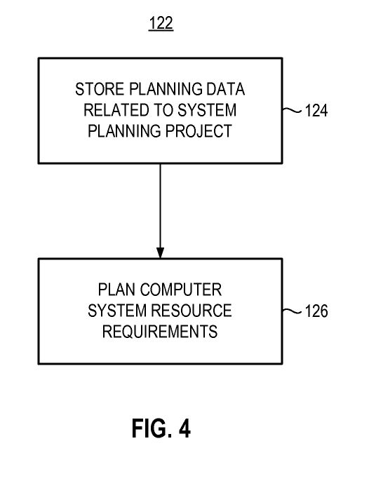

FIG. 4 illustrates a method flow diagram, shown generally at 122, representative of the method of operation of an embodiment of the present invention. The method facilitates planning of computer system resource requirements pursuant to a system planning project.

First, and as indicated by the block 124, planning data related to the system planning project is stored. The planning data is dynamically updateable.

Then, and as indicated by the block 126, the computer system resource requirements are planned for the system planning project. Then, and as indicated by the block 128, the computer system resource requirements are adjusted responsive to dynamic updates to the planning data.

Data is collected and maintained at a common data base and is thereafter used pursuant to capacity planning to determine computer resource requirements of a computer system configuration or upgrade. Problems and inefficiencies resulting from haphazard collection of data, on an ad hoc basis are less likely to occur.

The previous descriptions are of preferred examples for implementing the invention, and the scope of the invention should not necessarily be limited by this description. The scope of the present invention is defined by the following claims.

What is claimed is:

1. Apparatus for planning computer system resource requirements pursuant to a system planning project, said apparatus comprising:
a centralized data depository configured to store planning data related to the system planning project, the planning data dynamically updateable; and
a capacity planner adapted to utilize the planning data stored at said centralized data depository, said capacity planner configured to plan the computer system resource requirements for the system planning project and configured to adjust the plan responsive to dynamic updates to the planning data.

2. The apparatus of claim 1 wherein updated planning data that updates the planning data stored at said centralized data depository identifies an on-demand capability change.

3. The apparatus of claim 2 wherein adjustment to the plan formed by said capacity planner comprises an on-demand capability change resource allocation.

4. The apparatus of claim 1 wherein the planning data storable at said centralized data depository comprises hardware-related data and wherein the computer system resource requirements planned by said capacity planner comprise hardware requirements.

5. The apparatus of claim 4 wherein said capacity planner comprises a hardware selector configured to select hardware selector configured to select hardware pursuant to the hardware requirements.

6. The apparatus of claim 5 wherein said hardware selector is configured to select the hardware responsive to a value criteria.

7. The apparatus of claim 1 wherein said capacity planner is further configured to plan distribution of computer system traffic.

8. The apparatus of claim 7 wherein the distribution of the computer system traffic planned by said capacity planner comprises substantially even distribution across computer system resources defined by the computer system resource requirements.

9. The apparatus of claim 1 further comprising a graphical user interface configured to display an indication of plan made by said capacity planner.

10. The apparatus of claim 1 wherein the system planning project pertains to a selected computer system having a configuration management database and wherein computer system resource requirements planned by said capacity planner further provide for interaction with the configuration management database.

11. The apparatus of claim 1 further comprising a report generator configured to generate a report responsive to the planning data stored at said centralized data depository.

12. The apparatus of claim 11 wherein said report generator is further configured to generate a report responsive to the computer system resource requirements planned by said capacity planner.

13. The apparatus of claim 1 wherein said centralized data depository comprises a logically centralized data depository.

14. The apparatus of claim 1 wherein said centralized data depository comprises a physically centralized data depository.

15. A method for planning computer system resource requirements pursuant to a system planning project, said method comprising the operations of:
storing planning data related to the system planning project, the planning data dynamically updateable;
planning the computer system resource requirements for the system planning project; and
adjusting the computer system resource requirements responsive to dynamic updates to the planning data.

16. The method of claim 15 further comprising the operation of collecting the planning data stored during said operation of storing.

17. The method of claim 15 wherein said operation of planning comprises evaluating existing computer resource requirements.

18. The method of claim 15 wherein said operation of planning comprises evaluating future computer resource requirements.

19. The method of claim 15 wherein said operation of planning comprises determining whether additional computer system resources are required.

20. The method of claim 15 further comprising the operation of generating a report responsive to the computer resource requirements planned during said operation of planning.
